(19) United States
(12) Patent Application Publication
(10) Pub. No.: US 2004/0241046 A1
(43) Pub. Date: Dec. 2, 2004

(54) Method of, and apparatus for use in, the digestion of liquid samples

(76) Inventors: John Francis Bates, Cambridge (GB); Christopher George Perry, Cambridge (GB)

Correspondence Address: William M Lee Jr, Barnes & Thornburg, PO Box 2786, Chicago, IL, 60690-2786, US

(21) Appl. No.: 10/486,529

(22) PCT Filed: Aug. 9, 2002
(86) PCT No.: PCT/GB02/03689

(30) Foreign Application Priority Data
Aug. 10, 2001 (GB) 0119543.7

(51) Int. Cl. G01N 1/00

(52) U.S. Cl. 422/80; 436/175; 422/78

(57) ABSTRACT

Apparatus for digesting a liquid sample has sealed housing (18) containing a source (20) of ultra violet radiation, such as a medium pressure mercury discharge lamp, for irradiating a liquid sample being conveyed through a conduit (24) also in the housing (18). The source (20) emits ultra violet radiation, in a first frequency band, for generating ozone in the sample and in a second, lower frequency band for breaking chemical bands, and creating free radicals in the sample. The apparatus may include an analyser, such as an ion chromatograph (12) connected to the sample digester.

### FIELD OF THE INVENTION

This invention relates to a method of, and apparatus for use in, digestion of liquid samples, and to sample holding apparatus for presenting a liquid sample to a source of electromagnetic radiation to enable the sample to be digested for subsequent analysis. The invention also relates to a method of, and apparatus for, analysing a liquid sample.

### BACKGROUND TO THE INVENTION

The elemental analysis of liquid samples, in particular water-matrix samples, generally requires that a raw sample be initially digested so that the elements within any organic molecules present are converted to an inorganic form which can be more readily analysed.

Organic material which has been digested, for example by a process of oxidation, is more readily analysed using a range of detection systems which enable the measurement of the total amount of the particular element of interest contained within the sample. Digestion of a sample prior to analysis is of particular importance in the measurement of the total and total organic phosphorus, sulphur and nitrogen in compound. Various techniques for digesting liquid samples have been used, but have been problematic in particular for enabling analysis of elements whose oxides are not gaseous at ambient temperatures.

One such technique involves mixing the sample with an acid and boiling the mixture. Although relatively cheap, this technique is very slow and is potentially hazardous.

It is also known to irradiate a sample with microwave radiation or ultraviolet radiation. Microwave digestion is relatively fast, although expensive, and the vessels used to contain the sample being irradiated are prone to explode. Ultraviolet digestion is also fast, although the technique is of limited effectiveness, particularly if the samples are opaque or turbid. Current UV digestion techniques cannot effectively digest suspended solids, and involve the exposure of a sample to radiation from a low pressure UV lamp typically having a wave length in the region of 253.7 nM.

### SUMMARY OF THE INVENTION

According to a first aspect of the invention, there is provided apparatus for use in the digestion of liquid samples, the apparatus comprising source means for irradiating a liquid sample with electromagnetic radiation, and sample holding means for receiving a liquid sample in a position in which, in use, the sample is exposed to electromagnetic radiation from the source means, wherein the source means is operable to produce ultraviolet radiation, in a first frequency band, for generating ozone in the sample, so as to achieve at least a partial digestion of the sample, and ultraviolet radiation in a second frequency band, lower than the first band, for breaking chemical bonds and substances, and for creating additional free radicals, in the sample, wherein the sample holding means comprises a conduit situated at said position.

Conventional ultraviolet digestion apparatus tend to use low pressure UV lamps (particularly operating at less than 40 watts) which produce ultraviolet radiation mainly in the region of 253.7 nM. It has been found that, by exposing the sample to a broader range of frequencies (and preferably higher intensity) of UV radiation for the apparatus according to the invention is able to digest a sample far more efficiently than conventional UV digestion apparatus.

Preferably, the source means is such that the radiation in the first band comprises UVC radiation, preferably of a wave length (in free space) of less than 250 nM.

Preferably, the source means is such that its output spectrum also includes a peak in the region of 360 nM, said peak lying in the second band.

Preferably, the source means comprises a medium pressure mercury vapour lamp, in which the pressure of the mercury vapour in the lamp is at least one bar.

Preferably, the lamp has a power output of at least 400 watts.

Such a lamp emits very intense electromagnetic radiation across a broad spectrum from below 185 nM to above 200 nM. In addition to producing hydroxyl ions and other free radicals, the radiation is sufficient to excite and break many of the molecular bonds present in organic material. Additionally, the radiation is sufficiently intense to penetrate to a depth of at least 250 microns through semi-opaque and turbid liquid samples.

Preferably, the sample holding means further comprise an inlet and an outlet, connected by the conduit, the conduit defining a single path along which a sample has to pass from the inlet to the outlet.

This ensures that a sample can be flushed out of the sample holding means by introducing further liquid (for example a cleaning liquid or another sample) into the inlet. Preferably, the sample holding means comprises a backing member which supports a plate transparent to the radiation, the plate and the backing member defining between them a cavity which includes the conduit.

Preferably, the cavity is sufficiently thin to cause a sample therein to take the form of a film of, for example, less than 1 mm and preferably 0.25 mm thick.

The sample holding means may to advantage include guide means which, with the plate and base, defines the conduit.

Preferably, both the plate and the surface of the base which, with the plate, defines part of the cavity, are planar.

Preferably, therefore, the backing comprises a planar base plate which supports said other plate.

Preferably, the guide means comprises a channel in one of the plates.

Preferably, the conduit is of a generally serpentine shape.

Preferably, the apparatus includes a reflector for reflecting light from the source means onto the sample holding means.

Preferably, the reflector reflects ultraviolet radiation, but is substantially transparent to infrared radiation.

This feature enhances the exposure of the sample to the ultraviolet radiation, whilst not significantly increasing exposure to infrared radiation, and hence helps to prevent overheating of the sample.

Preferably, the reflector comprises part of a reflecting means that extend to the sides of the source and the opposite side of the source sample holding means.

Preferably, the source means and the sample holding means are both contained within a housing which is sealed to prevent escape of any gases generated in the housing by the action of the source in the sample, and which incorporates external formations which act as a heat sink well for conducting heat away from the interior of the housing. Preferably the housing is filled with an inert gas

According to a second aspect of the invention, there is provided a method of digesting a liquid sample, the method comprising the steps of conducting the sample along the conduit whilst exposing the sample to electromagnetic radiation from a source which generates ultraviolet radiation in a first band, for generating ozone and free radicals in the sample in sufficient quantities partially to digest the sample, the radiation also including ultraviolet radiation in a second, lower frequency band for breaking chemical bonds and creating free radicals in the sample.

Preferably, the first band includes the wave length of around 180 nM and 250 nM, and the second band includes the wavelength of 360 nM.

According to a third aspect of the invention, there is provided a method of digesting a liquid sample to enable the sample to be analysed, the method comprising the steps of conducting the sample along the conduit whilst exposing the conduit, and hence the sample therein to electromagnetic radiation from a medium pressure mercury vapour lamp, preferably operated at at least 400 watts.

According to a further aspect of the invention, there is provided apparatus for use in the digestion of liquid samples, the apparatus comprising a medium pressure mercury vapour lamp and sample holding means for holding a sample in the vicinity of the lamp and allowing the sample to be exposed to ultraviolet radiation emitted by the lamp, the sample holding means comprising a conduit through which the sample is transported whilst being exposed to said radiation.

According to yet another aspect of the invention, there is provided sample holding apparatus for presenting a liquid sample to a source of electromagnetic radiation to enable the sample to be digested by the radiation, the apparatus comprising a base and a transparent plate overlying the face, and further comprising guide means for defining the conduit between the face and the plate, the conduit being so dimensioned as to be capable of allowing the sample to pass therethrough.

Preferably, the base also comprises a plate, and both plates may to advantage be substantially planar.

Preferably, the guide means is integrally formed, for example as a track, in the base or plate, but the guide means may alternatively comprise an intermediate spacer film sandwiched between the base and plate.

The spacer film may to advantage be of a chemically inert material, and preferably defines a serpentine conduit.

### BRIEF DESCRIPTION OF THE DRAWINGS

The invention will now be described, by way of example only, with reference to the accompanying drawings in which:

FIG. 1 is a schematic diagram of apparatus, in accordance with the invention, for digesting and analysing a liquid sample;

FIG. 2 is a more detailed schematic, cut-away view of part of the apparatus shown in FIG. 1;

FIG. 3 is an exploded, simplified isometric view of apparatus for holding a sample in the apparatus shown in FIG. 2;

FIG. 4 is a plan view of part of the sample holding apparatus;

FIG. 4a is a sectional side view of that part;

FIGS. 5 to 9 are plan views of further components of the sample holding apparatus;

FIG. 10 is a more detailed view, in side elevation, of the part of the sample holding apparatus shown in FIG. 9, the figure showing heat cooling fins extending from the base of the apparatus;

FIG. 11 is a graph of the spectrum of radiation emitted by a light source forming part of the apparatus;

FIG. 12 is a cut away side view of the assembled sample digesting apparatus;

FIG. 13 is a side elevation of the apparatus;

FIG. 14 is a plan view of an example of de-bubbler that can form part of the apparatus of FIG. 1;

FIG. 15 is a partially exploded side view of a portion of the de-bubbler shown in FIG. 14;

FIG. 16 is a plan view of another portion of the de-bubbler; and

FIG. 17 is a partially exploded side view of the portion shown in FIG. 16.

### DETAILED DESCRIPTION

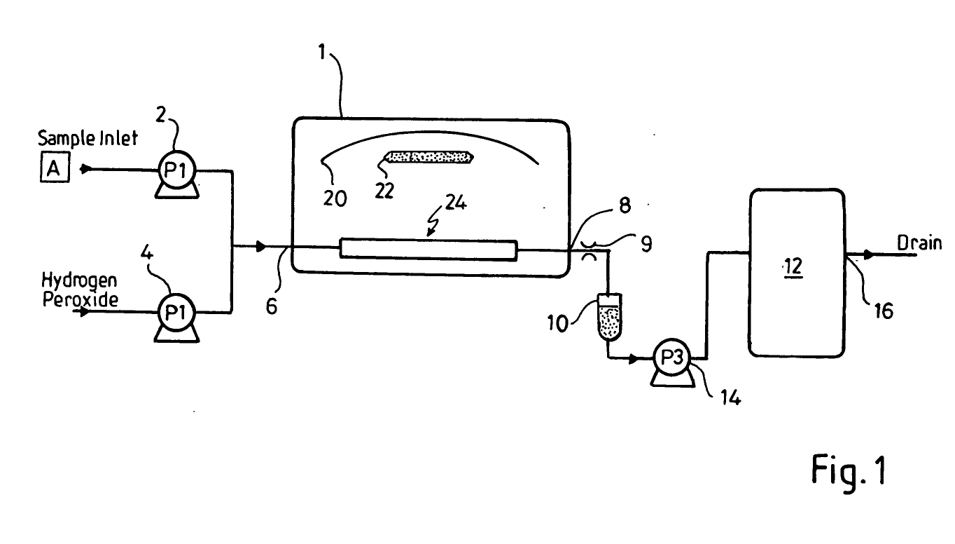

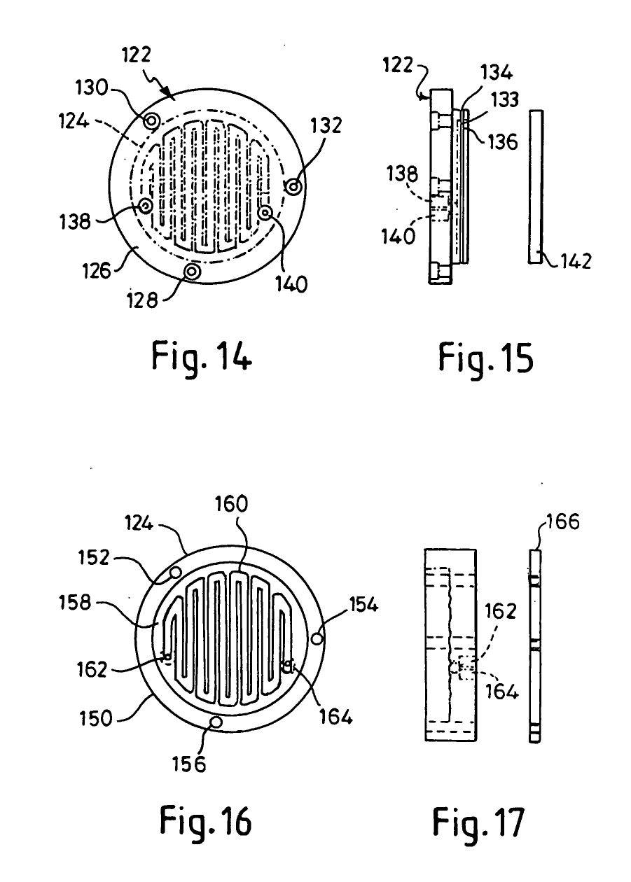

The apparatus shown schematically in FIG. 1 comprises a digestion module 1 and inlet pumps 2 and 4 which are connected to an inlet 6 of the module 1. The pump 2 is operable to supply a sample to the module, whilst the pump 4 supplies hydrogen peroxide for assisting in the digestion of the sample in the module 1. The digested sample is then passed from an outlet 8 in the module 1 to a collection vessel 10 via a flow restrictor 9. The collection vessel 10 comprises an in line de bubbler of the kind which uses a permeable membrane, to one side of which a vacuum is applied to remove bubbles of gas from the digested sample on the other side of the membrane. An example of such a de-bubbler is described in greater detail with reference to FIGS. 14 to 17. The apparatus is used in conjunction with a detector 12 in this case an ion chromatograph. Other types of detector, for example a Photometer or voltametric electrochemical analysis device may be used. In the case of a photometer being used the sample may be mixed with ammonium molybdate and ascorbic acid for detecting phosphorus. The sample from the vessel 10 is supplied to the detector 12 by a pump 14, and exits for detector 12 through a drain 16.

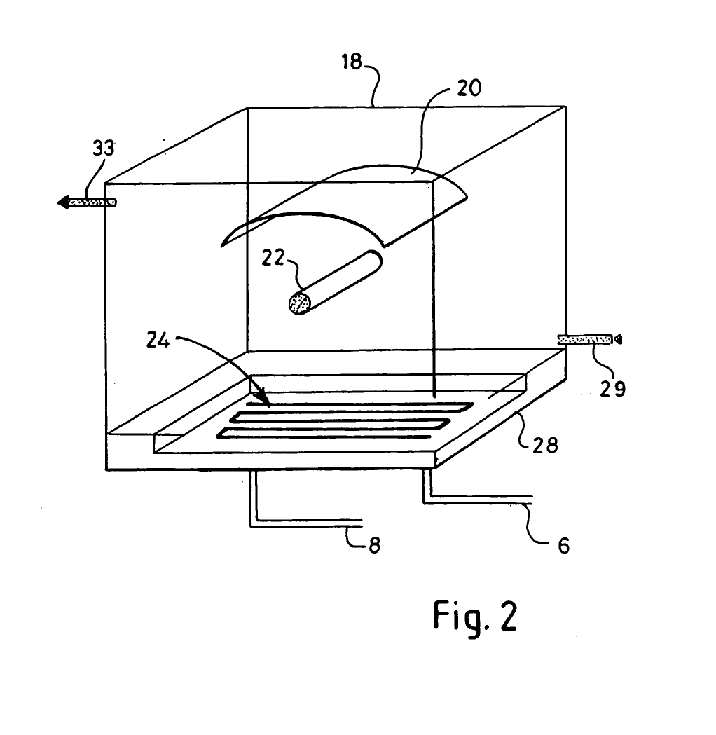

The digestion module is shown in more detail in FIG. 2, and comprises a gas-tight, cubic housing 18 which contains a curved quartz reflector 20 and a medium pressure mercury discharge lamp 22 positioned approximately at the focus of the reflector 20. The housing also includes mountings for attaching the lamp 22 and reflector 20 to the housing, and cable burrs to allow the lamp 22 to be connected to an external source of electrical energy, but these features have been omitted for the sake of clarity. The surface of the reflector 20 includes a dichroic coating which reflects as much as possible of the ultraviolet radiation produced by the lamp 22, whilst allowing infrared radiation (which would heat the sample if incident thereon) to pass through the reflector 20.

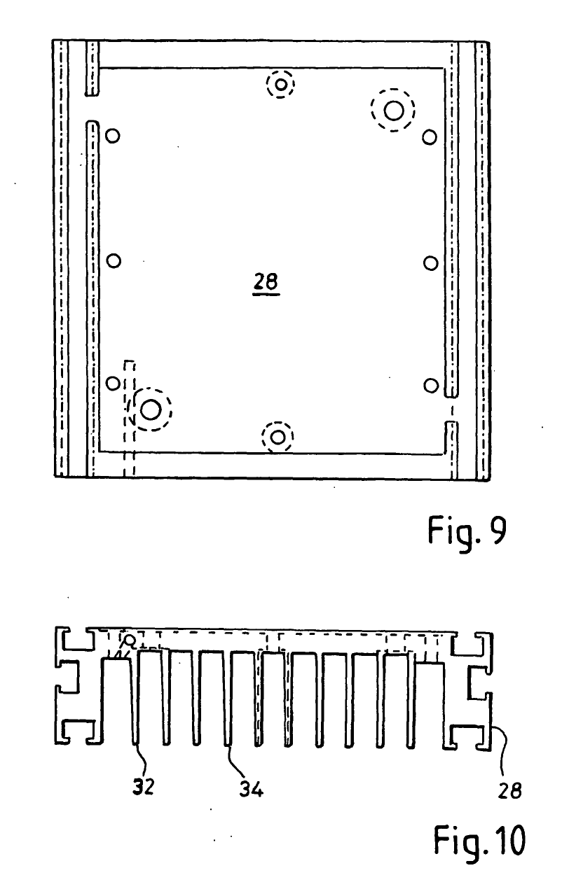

The sides, top and bottom of the housing 18 are formed from aluminium which is externally finned to act as a heat sink, and the apparatus can include ventilation fans for forcing air to travel over the external fins so as to conduct heat away from the interior of the housing. In the present example, there is provided a respective fan for the bottom and two of the sides and the top of the housing 18, although there may be provided six fans, one for each respective face of the housing. The construction of the housing i.e. described in more detail below, with reference to FIGS. 9, 10, 12 and 13. The housing 18 also has gas inlet and outlet ports 29 and 33 to enable the space in the housing to be flushed with an inert gas (such as argon), thereby to obviate the problems of ozone creation by the action of the radiation from the lamp 22 on gases in the headspace in the housing 18.

The lamp 22 has a nominal rating of 800 watts.

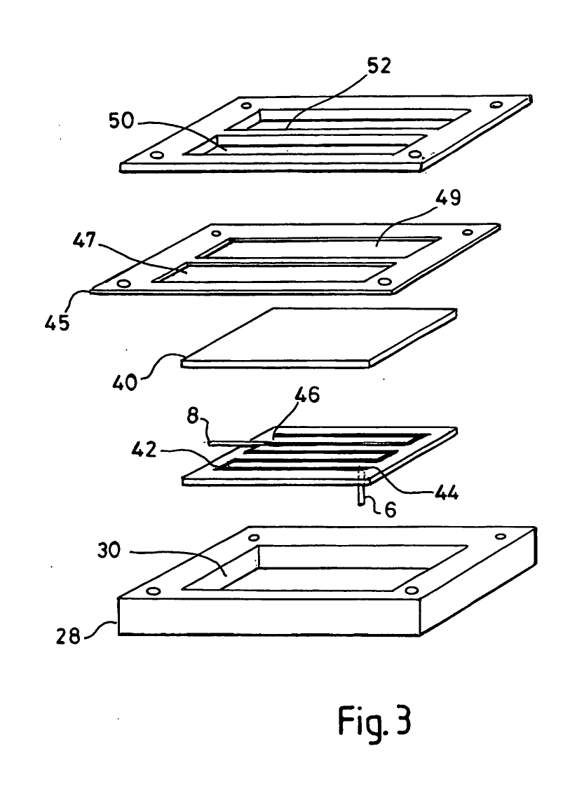

The reflector 20 and lamp 22 extend across substantially the entire width of a serpentine conduit 24 which is formed in sample holding apparatus 26 shown in more detail in FIGS. 3-6. The conduit is shown in simplified, shortened forms in FIGS. 2 and 3 for the sake of clarity.

The sample holding apparatus comprises a lower cooling sink 28 which also forms the bottom of the housing 18, and which is shown in more detail in FIGS. 9 and 10. The heat sink 28 is, when viewed in plan, substantially square and includes a central, square recess 30. The heat sink 28 is formed from aluminium and a number of elongate cooling fins, for example fins 32 and 34 shown in FIG. 10 project downwardly from the underside of the heat sink 28. As shown in FIG. 10, there are ten such fins which extend substantially vertically downwards and are parallel to each other. The fins also extend across the whole width of the underside of the heat sink 28, and the fins are substantially the same cross section along their entire length. The sink includes bores 31 and 33 to enable the inlet and outlet pipes 6 and 8 reach the conduit 24. The sides and top of the housing 18 have a similar arrangement of fins.

The recess 30 houses a quartz base plate 36 into one face of which a channel which defines a serpentine path 42 has been machined. A groove 25 extending around the perimeter of the top face of the plate 36 accommodates an O-ring seal 27 that seals against an upper quartz plate 40 that sits on the base plate 36. The recess 30 also houses an underlying graphite plate 35 (see FIG. 8) on which the plate 36 sits.

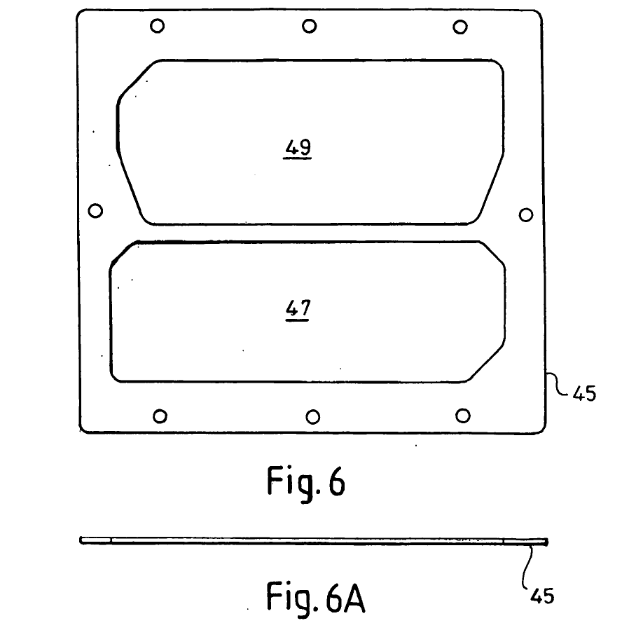

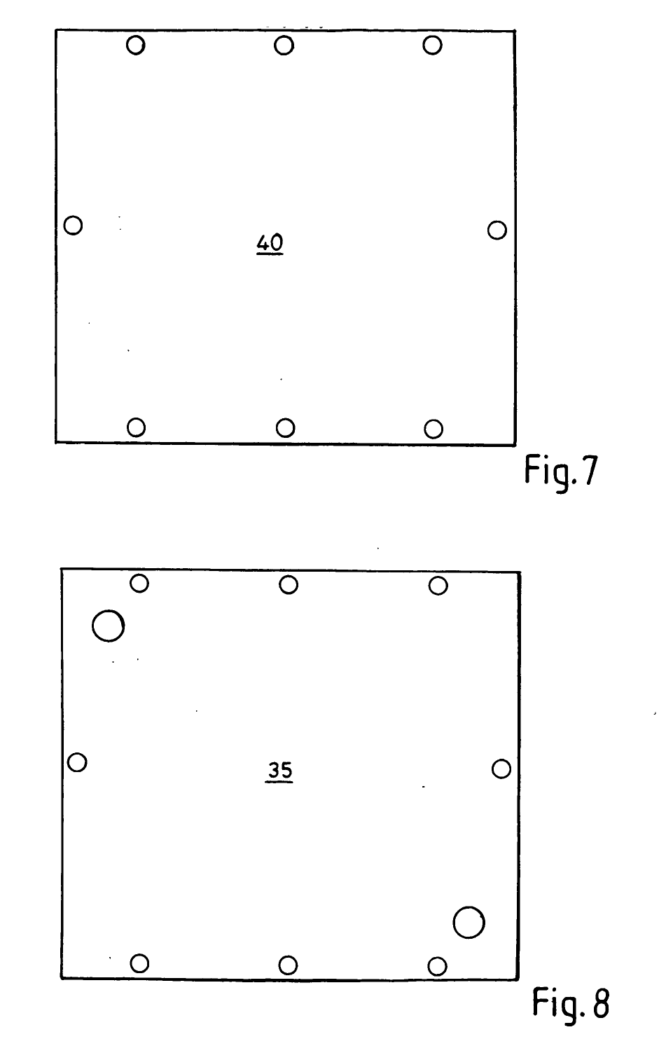

The ends of the path 42 are in registry with inlet and outlet openings 44 and 46 in the plate 36. The openings 44 and 46 accommodate the inlet and outlet conduits 6 and 8 respectively. A rubber gasket 45 overlies the periphery of the plate 28, seals against the plate 40 and has two central apertures 47 and 49 to allow light to reach the path 42. The gasket is shown in more detail in FIG. 6.

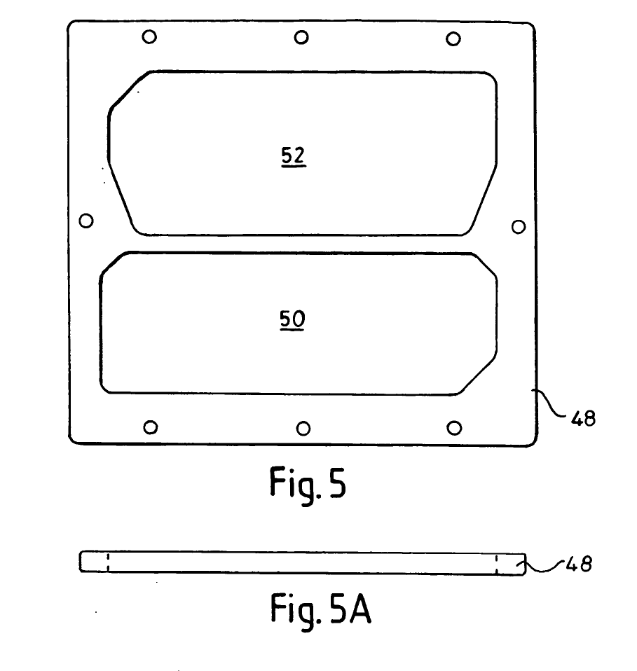

The plates 36 and 40 are held in position by an upper clamping plate 48 shown in more detail in FIGS. 5 and 5a. The clamping plate 48 has two central apertures 50 and 52 to allow light from the source 22 to reach the plate 40, and hence the channel 42. The plate 48 is directly screwed onto the cooling sink 28 by screws passing through eight apertures at the periphery of the plate 48 and heat sink 28. Those screws also pass through corresponding holes in the gasket 45 (shown in FIGS. 6 and 6A) so that the gasket is sandwiched between the plate 48 and the plates 40 and 28.

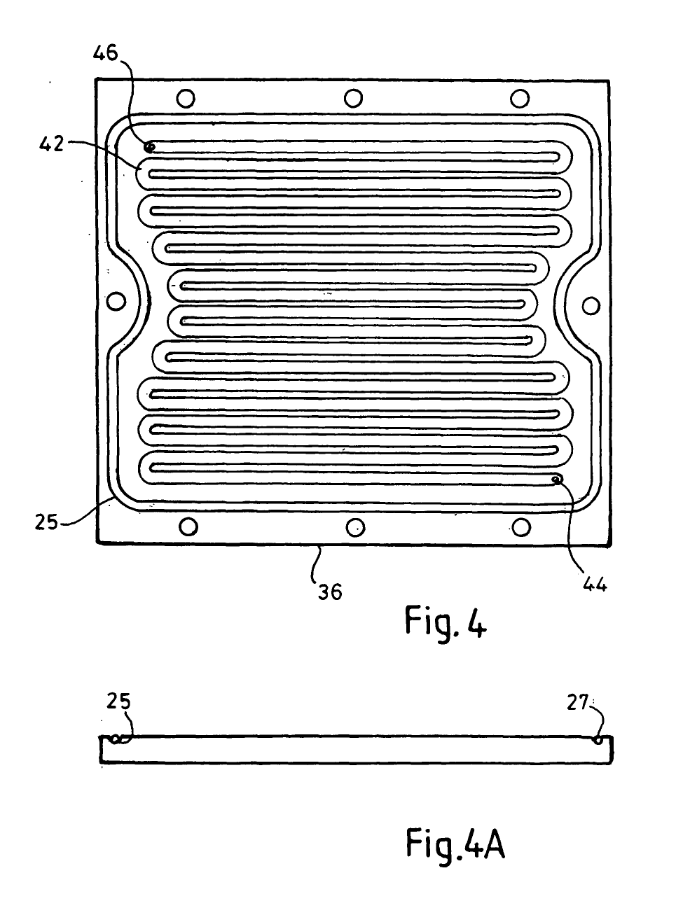

The channel 42 is shown in more detail in FIG. 4, from which it can be seen that the channel (and hence the serpentine conduit 24) has nineteen parallel runs interconnected by u-shaped end portions, to give the channel and conduit said serpentine shape.

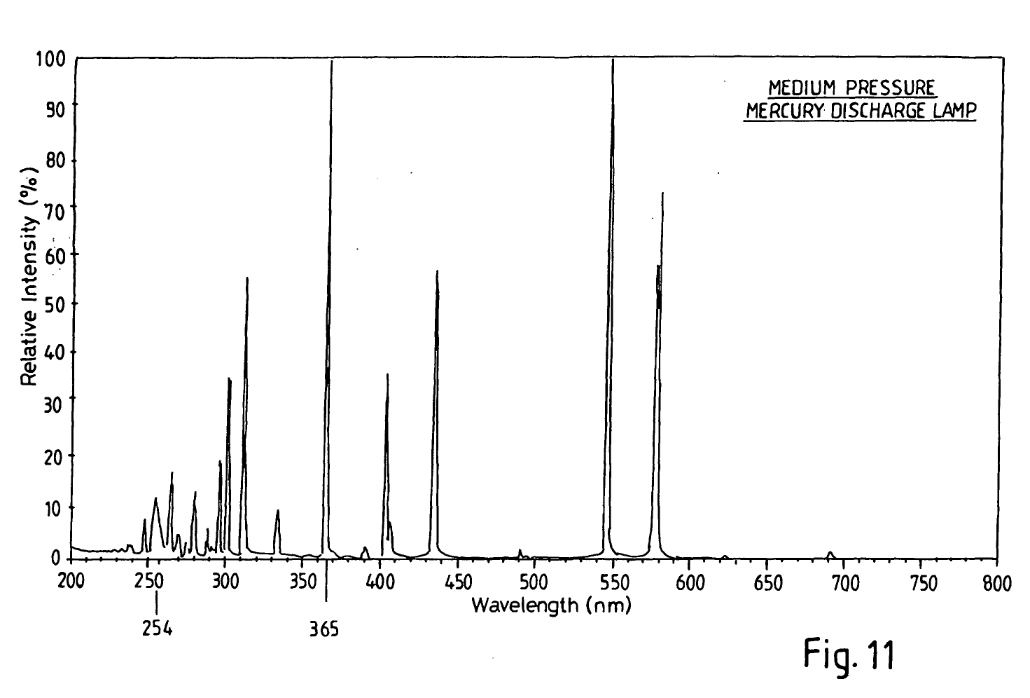

In use, a sample is introduced, for example manually or from an auto sampler to a transfer pipe at a point A shown in FIG. 1. The sample is then conveyed towards the inlet 6, and on its way is automatically dosed with a small amount (typically 2% by volume) of hydrogen peroxide (or in some case persulphate solutions may be used) before passing through the inlet pipe 6 and into the module 1. The mixture of sample and hydrogen peroxide then continues along the pipe 6 through the 46 in the heat sink 36 and into the conduit 42. The sample exits the pipe 6 at one end (reference 60) in FIG. 4 of the serpentine conduit 42. The sample travels along the serpentine conduit 42, and on its way is exposed to electromagnetic radiation from the lamp 2. FIG. 11 shows the spectrum of that radiation, which includes significant amount of radiation of a wavelength of less than 250 nM and a peak of radiation entered on approximately 365 nM. The first type of radiation generates a significant amount of ozone and free radicals in the sample travelling through the conduit 42 which helps to break down organic compounds, whilst the higher wavelength ultraviolet radiation causes further decomposition.

Some of the ultraviolet radiation from the lamp 22 travels directly to the sample, whilst radiation emitted from the opposite side of the lamp 22 is reflected onto the sample by the reflector 20. The reflector 20 preferentially reflects ultraviolet radiation, whilst passing infrared radiation, so as to reduce the heating effects of the lamp 22 on the sample. However, in view of the high power rating of the lamp 22, the external cooling fans and fins are used to ensure that the temperature of the sample does not exceed 80° centigrade, and the lamp is not allowed to overheat.

Since the conduit 42 is relatively thin, problems arising from attenuation of ultraviolet radiation within the sample can be mitigated or avoided, and the geometry of the conduit is such as to maximise a surface area of the sample whilst keeping its depth and any dead space (which could hold residual liquid) to a minimum. The use of dichroic reflectors helps to minimise the amount of infrared radiation (as a proportion of the total radiation) directed at the sample, and to allow the lamp to be in close proximity to the sample. The gasket seal 45 protects the quartz plate 40 and the O-ring seal prevents the escape of any sample.

It has been found that, by using this apparatus, adequate digestion can be achieved using just hydrogen peroxide which allows the samples to be analysed, for example with the ion chromatograph without interference from the introduction of more powerful reagents which themselves could introduce inaccuracies and interferences.

It will be appreciated that the apparatus may be modified without departing from the scope or spirit of the invention. For example, other components may be added, such as solenoid valves and bypass ducting to allow the system to be cleaned and calibrated at intervals, and also to enable a quantum of sample liquid (in all its organic forms) to be analysed in the analyser 4. The amount of any element detected in the detector 4 in such a portion can then be subtracted from the amount detected in the digested sample to provide a more accurate indication of the amount of the element of interest which was originally present in the organic compound in the sample.

During use, the housing 18 may be flushed out with an inert gas such as Argon or Helium. To that end the housing may have an inlet port for receiving such gas and an exhaust port through which displaced gas is dispelled. The inert gas may be supplied at a rate of 20 ml/min, and removed oxygen from the headspace in the housing 18, thus preventing the formation of ozone in the headspace by the action of the source 22.

In addition, further or alternative cooling systems may be used. For example, a heat pump such as a refrigeration unit or Peltier effect heat pump can be used.

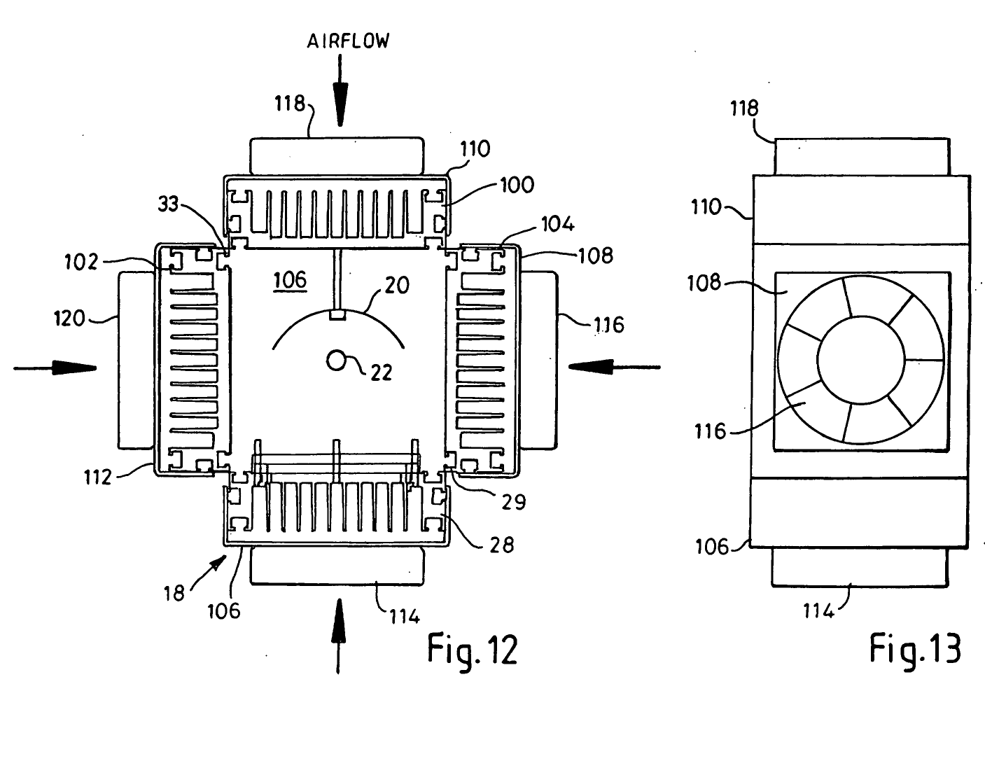

As can be seen from FIG. 12, the housing 18 provides a generally cubic inner volume bounded by the lower heat sink 28, upper heat sink 100, side heat sinks 102 and 104, a rear heat sink 106 and a front heat sink which has been omitted from FIG. 12 to reveal the interior of the housing 18. The upper, side and front and rear heat sinks are substantially identical to heat sink 28 save for the inclusion of the gas inlet and outlet ports 29 and 33 in the heat sinks 102 and 104 and the absence of inlet and outlet ports for the sample. Each of the heat sinks 28, 100, 102 and 104 carries a respective U-shaped bracket 106, 108, 110 and 112 extending over the outboard ends of the heat sink fins, and carrying a respective axial fan 114, 116, 118 and 120. The rear heat sink 106 and front heat sink 108 do not have the bracket and fan assemblies, but it is within the scope of the invention for these heat sink also to include such assemblies.

Adjacent heat sinks are sealed against each other by means of gaskets (not shown) which make the interior of the housing 18 both gas and light tight.

Turning to FIGS. 14 to 17, the digested sample leaving the housing 18 can contain gas bubbles which need to be removed before the sample is fed to the detector 12. To that end, the sample is fed through a de-bubbler. The de-bubbler shown in FIGS. 14 to 17 is considered to be particularly appropriate for this type of application, and comprises an upper housing portion 122 which, in use, is bolted to a lower housing portion 124, both housing portions being formed from a suitable plastics material, such as PEEK. The housing portion 112 comprises a circular plate 126 which is integrally formed with a peripheral flange provided with three angularly spaced through bores 128, 130 and 132 for the bolts for clamping the two housing portions together. An axial cylindrical wall 134 extends from one face of the plate 126, and defines a cylindrical recess 136. The top of the plate 126 is also formed with ports 138 and 140. The port 138 is, in use, connected to a vacuum pump, whilst port 140 acts as an air-bleed inlet to allow a controlled amount of air to bleed in to the de-bubbler in use.

The outboard end of the wall 134 acts as a shoulder against which is seated a circular sintered polypropylene support member 142. The support member is, by virtue of its sintered construction, porous so as to allow gas to pass through, and is coated on one side with 0.05 mm layer of Teflon AF (or other material permeable only to gases).

The housing portion 124 comprises a circular plate which also has a ring shaped peripheral flange 150 with bores 152, 154 and 156 which are, in use, in registry with the bores 132, 130 and 128 so as to allow the portions to be bolted together. The portion 124 also includes a cylindrical recess 158, the bottom of which is formed with a serpentine channel 160 having end inlet and outlet ports 162 and 164 respectively.

The diameter of the recess 158 is slightly larger than that of the wall 134, and the latter has an annular groove 133 for accommodating an O-ring seal. The arrangement is such that the wall 134 is a tight fit within the recess 158, and is sealed against the portion 124 by the O-ring seal.

The de-bubbler also includes a backing plate 166 through which the fixing bolts (to hold the two housing portions 122 and 124 together) extend. With the two housing portions clamped together, the Teflon coated side of the support 142 abuts the circular face of the recess 158 so as to define, with the channel 160, a serpentine conduit volume through which a digested sample passes from the inlet 162 to the outlet 164. The other side of the support 142 defines, with the wall 134 and the circular plate 126, a volume above the serpentine conduit which communicates with the vacuum port 138 and air bleed inlet 140.

In use, the port 138 is connected to a vacuum pump, and the digested sample is passed through the serpentine conduit as the pump is operated. The operation of the pump causes a reduction in the pressure of air in the volume over the serpentine conduit. The air bleed inlet can enhance the migration of a selected gas across the barrier by admitting gases that displace that gas out of the outlet volume, thereby reducing the partial pressure of the gas in the outlet volume. This reduction in pressure draws any gas bubbles in the liquid sample in the serpentine conduit through the Teflon AF coating and the polypropylene support 142 and into said volume, from which those gasses are expelled through the port 138.

1. Apparatus for use in the digestion of liquid samples, the apparatus comprising a source for irradiating a liquid sample with electromagnetic radiation, and a sample holder for receiving a liquid sample in a position in which, in use, the sample is exposed to electromagnetic radiation from the source, wherein the source is operable to produce ultraviolet radiation, in a first frequency band, for generating ozone in the sample, so as to achieve at least a partial digestion of the sample, and ultraviolet radiation in a second frequency band, lower than the first band, for breaking chemical bonds in substances in the sample, and for creating additional free radicals wherein the sample holder comprises a conduit situated at said position.

2. Apparatus according to claim 1, in which the source is such that the radiation in the first band comprises UVC radiation.

3. Apparatus according to claim 2, in which the source is operable to emit radiation of a wave length of less than 250 nm.

4. Apparatus according to claim 2, in which the source is such that its output spectrum also includes a peak in the region of 360 nm, said peak lying in the second band.

5. Apparatus according to claim 1, in which the source comprises a medium pressure mercury vapour lamp, in which the pressure of the mercury vapour in the lamp is at least one bar.

6. Apparatus according to claim 5, in which the lamp has a power output of at least 400 watts.

7. Apparatus according to claim 6, in which the lamp has a nominal power rating of 800 watts.

8. Apparatus according to claim 1, in which the sample holder further comprises an inlet and an outlet, connected by the conduit, the conduit defining a single path along which a sample has to pass from the inlet to the outlet.

9. Apparatus according to claim 1, in which the sample holder comprises a backing member which supports a plate transparent to the radiation, the plate and the backing member defining between them a cavity which includes the conduit.

10. Apparatus according to claim 9, in which the cavity is sufficiently thin to cause a sample therein to take the form of a film of less than 1 mm.

11. Apparatus according to claim 10, in which the cavity causes a sample therein to take the form of a film which is 0.25 mm thick.

12. Apparatus according to claim 9, in which the sample holder includes guide which, with the plate and base, defines the conduit.

13. Apparatus according to claim 9, in which both the plate and the surface of the base which, with the plate, defines the cavity, are planar.

14. Apparatus according to claim 13, in which the backing comprises a planar base plate which supports said other plate.

15. Apparatus according to claim 13 in which the guide means comprises a channel in one of the plates.

16. Apparatus according to claim 1, in which the conduit is of a generally serpentine shape.

17. Apparatus according to claim 1, in which the apparatus includes a reflector for reflecting light from the source onto the sample holder.

18. Apparatus according to claim 17, in which the reflector reflects ultraviolet radiation, but is substantially transparent to infrared radiation.

19. Apparatus according to claim 17 in which the reflector comprises part of a reflector that extends to the sides of the source and the opposite side of the source sample holder.

20. Apparatus according to claim 1, in which the source and the sample holder are both contained within a housing which is sealed to prevent escape of any gases generated in the housing by the action of the source on any gas in the housing, and which incorporates external formations which act as a heat sink for conducting heat away from the interior of the housing.

21. A method of digesting a liquid sample, the method comprising the steps of conducting the sample along a conduit whilst exposing the sample to electromagnetic radiation from a source which generates ultraviolet radiation in a first band, for generating ozone and free radicals in the sample in sufficient quantities partially to digest the sample, the radiation also including ultraviolet radiation in a second, lower frequency band for breaking chemical bonds and creating free radicals in the sample.

22. A method according to claim 21, in which the first band includes the wave length of around 180 nM and 250 nM, and the second band includes the wavelength of 360 nM.

23. A method of digesting a liquid sample to enable the sample to be analysed, the method comprising the steps of conducting the sample along the conduit whilst exposing the conduit, and hence the sample therein to electromagnetic radiation from a medium pressure mercury vapour lamp, preferably operated at at least 400 watts.

24. A method of analysing the constitution of a liquid sample, the method comprising the steps of digesting the sample by a method according to claim 21 and then analysing the constitution of the digested sample.

25. A method according to claim 24, in which the step of analysing the digested sample is performed by means of a method of ion chromatography.

26. Apparatus for use in the digestion of liquid samples, the apparatus comprising a medium pressure mercury vapour lamp and sample holder for holding a sample in the vicinity of the lamp and allowing the sample to be exposed to ultraviolet radiation emitted by the lamp, the sample holder comprising a conduit through which the sample is transported whilst being exposed to said radiation.

27. Sample holding apparatus for presenting a liquid sample to a source of electromagnetic radiation to enable the sample to be digested by the radiation, the apparatus comprising a base and a transparent plate overlying the base, and further comprising a guide for defining the conduit between the face and the plate, the conduit being so dimensioned as to be capable of allowing the sample to pass therethrough.

28. Sample holding apparatus according to claim 27, in which the base also comprises a plate, and both plates are substantially planar.

29. Sample holding apparatus according to claim 26, in which a guide is integrally formed as a track in the base or plate.

30. Apparatus for analysing a liquid sample, the apparatus comprising apparatus according to claim 1, and an analyser for analysing the constituted digested sample, said analyser being connected to the conduit.

31. Apparatus according to claim 29, in which the analyser comprises a ion chromatograph.

32. A device for removing bubbles of gas from a sample of liquid supplied from sample digesting apparatus, the devise comprising a conduit, part of which is defined by a barrier which is selectively permeable so as to allow the passage of gas, but not liquid, through the barrier, an outlet volume on the opposite side of the barrier from the conduit and a connector for connecting the volume to a vacuum source.

33. A device according to claim 32, in which the conduit defines a single path along which the sample has to pass from on inlet to an outlet of the conduit.

34. A device according to claim 33, in which the conduit is of a generally serpentine shape.

35. (Cancelled)
